(19) United States
(12) Patent Application Publication
(10) Pub. No.: US 2006/0146794 A1
(43) Pub. Date: Jul. 6, 2006

(54) Peer network interaction facilitation method

(75) Inventors: William N. Shores, Phoenix, AZ (US); Thomas Peter Emmons JR., Mesa, AZ (US); Thomas G. Hallin, Erie, CO (US); Leonard K. Pennock, Chandler, AZ (US); J.C. Stanaway, Wheaton, IL (US)

Correspondence Address: MOTOROLA, INC., LAW DEPARTMENT, 1303 E. ALGONQUIN ROAD, SCHAUMBURG, IL, 60196, US

(73) Assignee: Motorola, Inc.

(21) Appl. No.: 11/026,959

(22) Filed: Dec. 30, 2004

(51) Int. Cl. H04L 12/66

(52) U.S. Cl. 370/352; 370/401

(57) ABSTRACT

These teachings facilitate interaction between two or more communication networks (10 and 11) comprising separate and discrete communication system peers. At least one of these networks is functionally partitioned with respect to interrogation and call signaling procedures over a plurality of geographic service areas (14, 15, and 16). Gateways (12 and 13) permit interaction between these networks, wherein at least some of the gateways provide functionally partitioned interrogation and call signaling procedures for some, but not all, of the plurality of geographic service areas. Upon receiving (32) a call routing message from a source from a remote communication network, which message identifies a target communication unit that is currently serviced by the first communication network, such a gateway can process (33) that call routing message as a function, at least in part, of a home geographic service area and a serving geographic area as corresponds to the target communication unit.

### TECHNICAL FIELD

This invention relates generally to interaction between two or more discrete and separate communication system peers.

### BACKGROUND

Communication systems of various kinds are known. At present, numerous discrete communication systems operate as separate peers with respect to one another. For example, both cellular telephony wireless communication systems and iDEN® wireless communication systems operate independently of one another and provide wireless communication services to their respective subscribers. Notwithstanding the separate and distinct nature of these deployed systems, however, in many cases it is desirable or even essential that at least some interaction between such peer systems be supported. For example, it may be desirable to support a communication between subscribers of two such peer systems.

Various approaches exist to support and facilitate such interaction. In general, relatively high-density connectivity tends to characterize present successful efforts (where, for example, each node essentially links directly to every other available node). Unfortunately, this approach holds poor prospects for any going-forward scenario that anticipates system growth. In general, this approach scales badly; in particular, as systems grow in size and/or complexity, an even greater increase is experienced with respect to required corresponding connectivity. This, in turn, quickly renders this approach both cost ineffective and ultimately undeployable.

Attempts to support such interconnectivity using reduced connectivity topologies has introduced other difficult problems relating, in particular, to call processing inefficiency. Long call setup delays become more common, and excessive queries to subscriber databases (such as, for example, Home Location Registers (HLRs)) become more common. Excessive rerouting (and/or redirecting) of calls also occurs.

As a result, interconnectivity as between peer networks in many cases remains problematic and tending towards unsatisfactory performance and/or cost.

### BRIEF DESCRIPTION OF THE DRAWINGS

The above needs are at least partially met through provision of the peer network interaction facilitation method described in the following detailed description, particularly when studied in conjunction with the drawings, wherein:

FIG. 1 comprises a block diagram as configured in accordance with various embodiments of the invention;

FIG. 2 comprises a block diagram as configured in accordance with various embodiments of the invention;

FIG. 3 comprises a flow diagram as configured in accordance with various embodiments of the invention;

FIG. 4 comprises a flow diagram as configured in accordance with various embodiments of the invention;

FIG. 5 comprises a flow diagram as configured in accordance with various embodiments of the invention;

FIG. 6 comprises a flow diagram as configured in accordance with various embodiments of the invention;

FIG. 7 comprises a call flow diagram as configured in accordance with various embodiments of the invention; and

FIG. 8 comprises a flow diagram as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, interaction between at least a first and a second communication network are facilitated (where these networks comprise discrete and separate communication system peers). In a preferred approach, at least one of these networks is functionally partitioned at least with respect to interrogation and call signaling procedures over a plurality of geographic service areas.

To effect this facilitation, and pursuant to a preferred approach, one provides a gateway for at least the first communication network. This gateway provides functionally partitioned interrogation and call signaling procedures for a first one of the plurality of geographic service areas but not for at least one other of the plurality of geographic service areas. Upon then receiving a call routing message (comprising any of a wide variety of call signaling messages such as, but not limited to, a Session Initiation Protocol INVITE message) from a source in the second communication network, which message identifies a target communication unit that is currently serviced by the first communication network, one then processes the call routing message as a function, at least in part, of a home geographic service area and a serving geographic service area as corresponds to the target communication unit.

In accordance with the needs and/or capabilities of a given application, this processing can comprise determining whether the call routing message identifies a specific call signaling server in the first communication network. When true, a decision to use, or to not use, the identified specific call signaling server can be based, at least in part, upon an ascertained status of one or more network elements and/or items of information. It is also possible, depending again upon the needs or capabilities of a given application, to condition or influence such processing with respect to the availability or lack of availability of pertinent cached information. Serving capability can also be taken into account if desired.

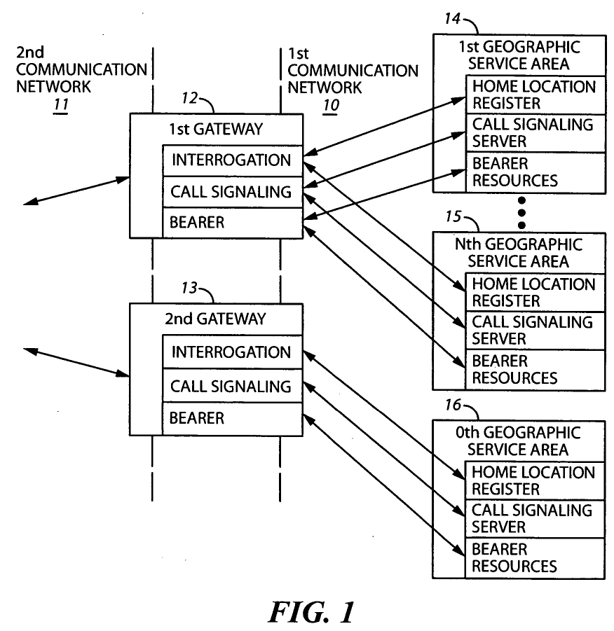

These and other benefits may become clearer upon making a thorough review and study of the following detailed description. Referring now to the drawings, and in particular to FIG. 1, these teachings are applicable for use with a wide variety (and any number) of communication systems. For purposes of illustration, however, two communication networks 10 and 11 that comprise discrete and separate communication system peers will be referred to in this description (where the first communication network 10 might comprise, for example, an iDEN® wireless communication system and the second communication network 11 might comprise, for example, a so-called 3G cellular telephony communication network). The first communication network 10 is parsed into a plurality of geographic service areas where each geographic service area is characterized by a corresponding Home Location Register (HLR) (or a plurality of such Registers), a call signaling server (or a plurality of such servers), and a plurality of bearer resources, all being well understood in the art. As is also understood in the art, some of these geographic service areas may have corresponding areas of coverage that overlap to some extent (or even completely) with one another. So configured, these resources as characterize each such geographic service area are applied to support the communication needs of communication endpoints that subscribe or are otherwise entitled to the services of the first communication network 10.

Pursuant to a preferred approach, a plurality of gateways are also deployed to effect interaction between the first and second communication networks 10 and 11. Two such gateways 12 and 13 are shown, but it will be understood that there is no particular upper limit regarding how many gateways may serve in a given application. In a preferred approach, at least some (and preferably all) of these gateways provide functionally partitioned interrogation (i.e., queries to a subscriber database such as a Home Location Register to determine a target's registered service location) and call signaling procedures (i.e., signaling and interworking procedures required or useful to establish and/or maintain a call between an originating and a target call server from respective peer networks) for one or more (but not all) corresponding geographic service areas of the first communication network 10.

For example, and as a non-exhaustive illustration of this point, the first gateway 12 in this embodiment provides functionally partitioned interrogation and call signaling procedures for a first through an Nth geographic service area 14 and 15, but not for an Oth geographic service area 16. In turn, a second gateway 13 provides such support for the Oth geographic service area 16 but not for the earlier-mentioned geographic service areas 14 and 15. In a preferred approach, while one gateway may serve a plurality of geographic service areas (though not all available geographic service areas), each geographic service area is served by only a single gateway.

Such an architecture means, for example, that the first gateway 12 cannot interrogate the Home Location Register as corresponds to the Oth geographic service area 16 though it can interrogate the Home Location Register of, for example, the first geographic area 14. Those skilled in the art will recognize that this contrasts sharply with the more fully-meshed configurations that typify a prior art deployment. This more lightly-meshed configuration in turn facilitates less complicated increased scaling. In particular, the number of geographic service areas supported, and the number of gateways used to effect that support, can be greatly increased without also exponentially increasing the corresponding fabric that couples the former to the latter.

It will also be appreciated that, in effect, any given gateway may support in a given instance both, one, or neither of the interrogation and call signaling functions depending, typically, on:

the target's home geographic service area;

the target's current registered geographic service area; and/or

the availability of useful cached routing information as gleaned from a previous call (or calls).

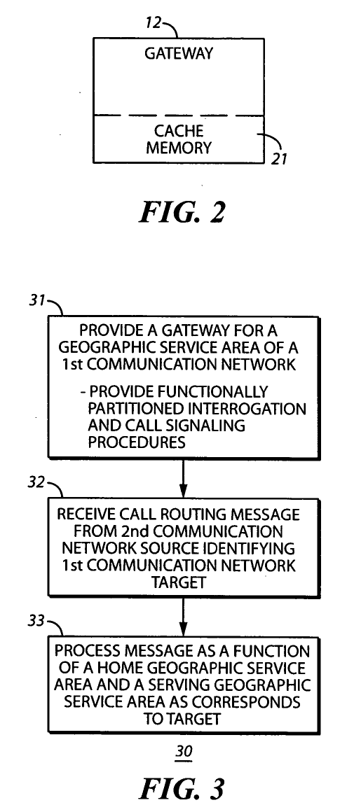

In an optional but preferred approach, and referring now to FIG. 2, at least one of these gateways (and preferably all of these gateways) also comprise some useful quantity of cache memory 21. As will be shown below in more detail, such cache memory 21 can serve to cache useful information that can be later retrieved and applied in support of communications both from the first communication network 10 to the second communication network 11 and vice versa.

Referring now to FIG. 3, such an architectural configuration reflects a preferred process 30 wherein one provides 31 at least one gateway for a first communication network that provides functionally partitioned interrogation and call signaling procedures for at least a first one of a plurality of geographic service areas, but not for at least one other geographic service area as comprises a part of that first communication network. Upon receiving 32 a call routing message from a source in a second communication network, which call routing message identifies a target communication unit that is currently serviced by the first communication network, this process 30 then effects processing 33 of that call routing message as a function, at least in part, of a home geographic service area and a serving geographic service area as corresponds to that target communication unit.

As a general proposition, this approach permits and facilitates the earlier described deployment of less-than-fully-meshed gateways. This, in turn, permits a degree of scalability that is quite lacking in prior solutions. Further details regarding these receiving and processing steps are provided below.

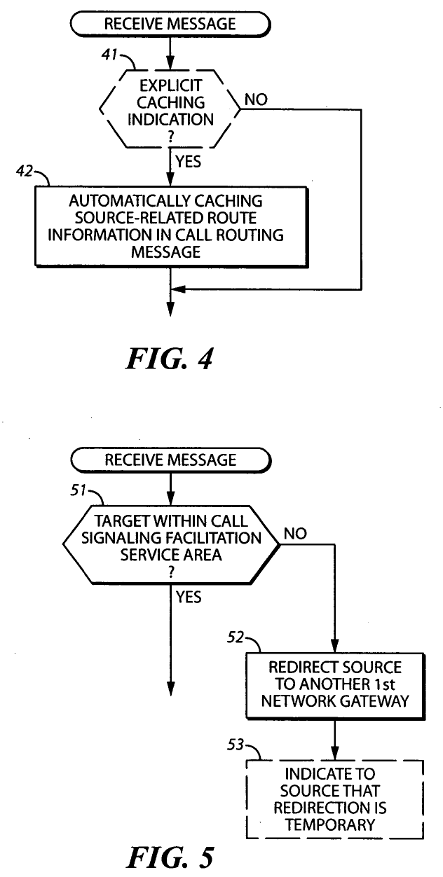

As already described above, such a gateway will receive, from time to time, call routing messages from a source in a remote communication network that identifies a target within the communication network served by the gateway. As an optional but preferred approach, and referring now to FIG. 4, the gateway may be configured and arranged to automatically cache 42 information as corresponds to route information as corresponds to the source as is contained in the call routing message. Caching such information may reduce the need for subsequent communications to determine an appropriate route when effecting a future communication from a source within the first communication network via the gateway to a target in the remote communication network, which target is one and the same as the present source. Such automatic caching can be based upon any number of triggering criteria including, but not limited to, detecting 41 an explicit indication in, for example, the received call routing message that prompts such caching. (This explicit indication might comprise, for example, a Session Initiation Protocol-INVITE message that indicates a permanent move to a receiving element. More particularly, the contact header portion of the INVITE message can include a new extension that comprises an explicit indicator to the recipient to cache this contact information for use with future requests (as versus merely temporarily caching the contact information for use during the context of this particular call as characterizes present practice).)

Regardless of whether the gateway effects such caching functionality, and referring now to FIG. 5, upon receiving such a call routing message the gateway will preferably then determine 51 whether the identified target communication unit is within a geographic service area that corresponds to the extant call signaling facilitation services of that gateway. This can be achieved in various ways including through use of locally available information and/or by interrogation of remote facilities that harbor all or part of the information needed to permit the determination to be made. When true, the gateway can then automatically respond by directing a corresponding call facilitation message to a call signaling service as corresponds to the target communication unit.

When not true, however, the gateway can respond by automatically redirecting 52 the source to another gateway for the first communication unit. Although the gateway could forward the message on to the identified gateway, by redirecting the source to the new gateway the source (via, for example, its own gateway) has the opportunity to cache the new routing information and to use it going forward to essentially avoid a sequence of multiple communication hops that tend to characterize message forwarding techniques.

As an optional but preferred step, the gateway can also indicate 53 to the source that this redirection comprises a temporary redirection (using, for example, a Session Initiation Protocol-compatible 302 message as is understood in the art). This indication can be used by a recipient network element, such as a receiving gateway, to discourage the recipient element from caching the corresponding routing information, as this temporary redirection may well be non-applicable in a future instance. So configured, the gateway serves to ascertain whether the target is presently within a geographic service area of the first communication network that is serviced by the gateway (recalling again that, pursuant to a preferred deployment, this gateway is not meshed to each and every geographic service area that comprises the first communication network). When not true, (meaning that the target is not presently within a geographic service area effectively coupled to the gateway), the gateway can respond by redirecting the source to another gateway for the first communication network and can also, if desired, indicate that this redirection is temporary to accommodate a situation where, for example, a target that is ordinarily serviced via a particular Home Location Register for a particular geographic service area that is coupled to the gateway has temporarily roamed to a geographic service area that is not coupled to the gateway.

The aforementioned redirection can occur in any of a variety of ways. As one example, and presuming the absence of any useful information upon which to base a decision, the gateway can simply redirect the call to a home gateway based on available network configuration data. Or, as an alternative and presuming the availability of pertinent information (as may be available via, for example, a Home Location Register that is accessible to the gateway and/or via previously cached information), the gateway may be able to redirect the source to another gateway that, in fact, likely provides present support to the target. When certain of the accuracy of such redirection information, if desired, the gateway can also include an indication in the redirection message to specify the vouched-for status of the redirection information.

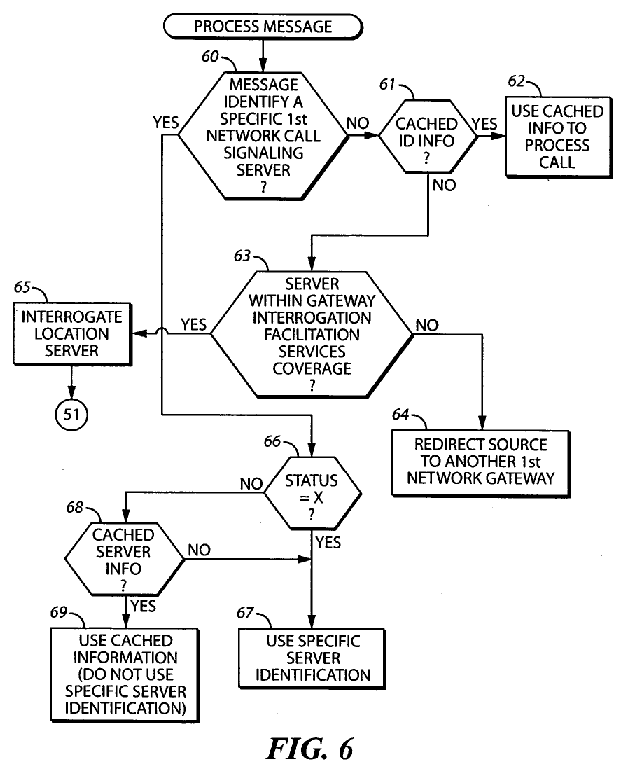

Referring now to FIG. 6, the aforementioned processing actions of the gateway can preferably comprise determining 60 whether the received call routing message identifies a specific call signaling server as comprises a part of the first communication network. When the message does not contain such an indication, the gateway can then ascertain 61 whether cached information regarding identification of an appropriate call signaling server is otherwise available to the gateway. When true, the gateway can then use 62 that cached information to process the call routing message.

When the call routing message does not identify a specific call signaling server as comprises a part of the first communication network, and such information is not otherwise available in the gateway's cache memory, the gateway can then determine 63 whether the location server for the target communication unit is within a geographic service area as corresponds to the interrogation facilitation services coverage of the gateway.

When false, the gateway can respond by automatically redirecting 64 the source to another gateway for the first communication network that is known to facilitate interrogation services for the target communication unit. In this event, it may also be desirable to provide an automatic indication to the source that this redirection comprises a non-temporary redirection (via, for example, a Session Initiation Protocol-compatible 301 message as is known in the art). Such an indication can be used by a recipient device, such as a recipient gateway, to prompt caching of the routing information to thereby aid in avoiding redirection in support of subsequent communications. Again, selection of the particular gateway to which the source is redirected can be effected in any of a variety of ways with a particular selection technique or criteria depending upon the needs and/or resources and capabilities that characterize a given application.

When the gateway determines 63 that the location server for the target communication unit is within a geographic service area as corresponds to the call signaling facilitation services coverage of the gateway, the gateway can then interrogate 65 a corresponding location server and then proceed to determine 51 whether the target is within a call signaling facilitation service area (as described above with respect to FIG. 5).

When the gateway determines 60 that the message does in fact identify a specific first network call signaling server, the gateway can then determine 66 whether that call routing message also comprises or otherwise indicates or identifies a particular status of relevance to these processes. In particular, the identification of a specific call signaling server may be accompanied by a specific indicator that effectively vouches for the accuracy of the specific call signaling server as being a correct one. This has particular relevance when the received call routing message itself comprises a response to an earlier received redirection message from another gateway that serves the first communication network. For example, that earlier gateway, in addition to ascertaining its own inability to service the call via its own geographic service areas, may have been able to also ascertain with certainty a present location of the target. In such a case, the prior gateway may have not only provided a redirection instruction but may also have included an indication that essentially vets the provided information as being current and accurate. The receiving element, upon then forming its renewed call routing message, may then include this (or a corresponding) indication regarding this vouched-for status of the accompanying information.

When this indicated status matches or otherwise corresponds in some required fashion to a predetermined status X (for example, a vouched-for status as described above), the gateway can then preferably use 67 the provided identification of the specific call signaling server as appears in the call routing message when processing the call routing message.

When not true, however, meaning that the identified status does not accord in a required fashion with a predetermined standard or value, the gateway can instead preferably ascertain 68 whether cached information regarding identification of an appropriate call signaling server is otherwise available to the gateway. When true, the gateway can then use 69 that cached information in lieu of the specifically identified call signaling server to process the call routing message. When not true (which may reflect either an absence of relevant cached information or only the availability of likely stale or outdated cached information), the gateway can instead still opt to use 67 the information identifying the specific call signaling server.

So configured, the gateway is able to respond usefully and dynamically to a variety of call routing circumstances. For example, the gateway can effectively handle both call routing messages that specify a particular call signaling server and those that do not, in part through provision of an ability to automatically determine its own interrogation capabilities. The gateway is also provided with an ability to make dynamic use of its own serving capabilities and, just as importantly, its knowledge regarding its lack of serving capabilities in some instances. These avenues of response, in turn, aid in mitigating long call setup delays, excessive queries to subscriber databases, and the excessive rerouting (or redirecting) of calls.

In effect, certain available techniques (such as Session Initiation Protocol-based routing, caching, and addressing) are leveraged (through use and/or extension) in new ways to effect these desired results. By functionally partitioning independent support of interrogation procedures from call signaling procedures as described, a gateway can ascertain its ability to support both, one, or neither of these activities with respect to any given incoming call from a peer network. In particular, the gateway is able to leverage this configuration through use of a given target's home geographic service area, the target's current registered geographic service area (which may comprise an area to which the target has roamed), and/or the availability of useful or potentially useful cached routing information from a previous call or calls.

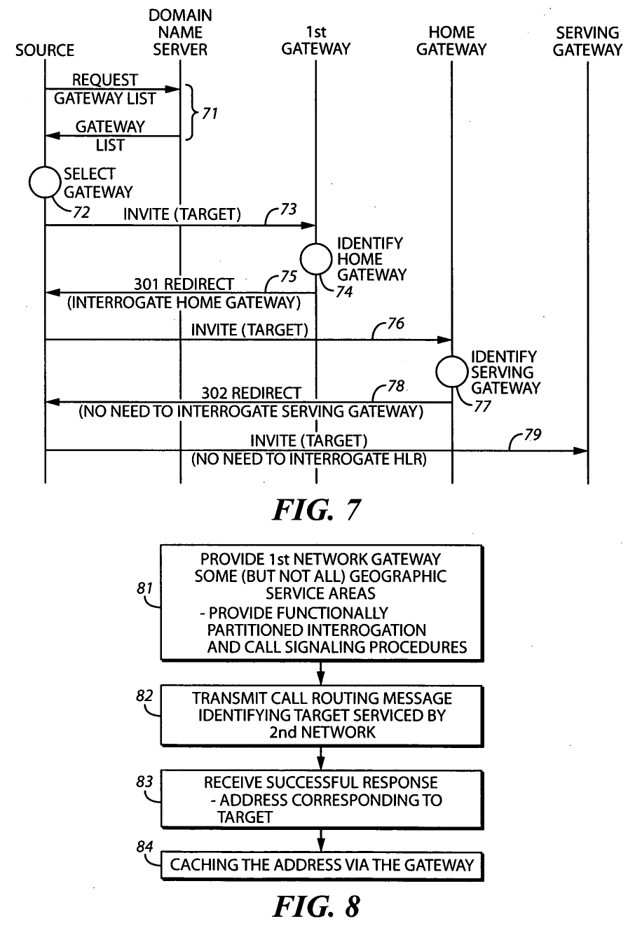

Those skilled in the art will especially appreciate the (sometimes dramatic) reduction in redirection messages and interrogation messages that can be achieved via deployment of these teachings. To illustrate, and referring now to FIG. 7, a source external to a given communication system, when seeking to establish a communication link to a target to that given communication system may lack any knowledge regarding a present location of that target aside from knowing the domain name for that communication system. That source can interact 71 with a domain name server in accordance with existing practice to obtain a list of gateways for that communication system. Notwithstanding the availability of this list, of course, the source in this illustrative example will still lack any specific information to correlate a given one of the listed gateways to the target of interest.

The source can then simply select 72 a first one of the listed gateways using any desired selection mechanism (including but not limited to a simple random selection) and transmit an INVITE message 73 to that first gateway. This INVITE message 73, of course, will identify the target. In this example, and due to the unmeshed nature of the preferred system configuration, the first gateway does not comprise a gateway having access to the Home Location Register for the target.

This first gateway, however, will have access to information that correlates the target to a given one of the system's gateways that does have such access. The first gateway can therefore identify the home gateway 74 for this target and issue a 301 REDIRECT message 75 to the source that identifies the home gateway for the target (which home gateway has access to the Home Location Register for the target). This 301 REDIRECT message 75 comprises, pursuant to these teachings, a message indicating that the purpose of the redirection is to facilitate a subsequent interrogation of the home gateway.

The source responds by directing an INVITE message 76 to the home gateway as was identified in the 301 REDIRECT message 75. This home gateway has access to the Home Location Register for the target. In this illustrative example, however, the target is not registered in its home region. Instead, in this example, the target has roamed to another region and hence the home gateway does not presently comprise the serving gateway for the target. In accord with present practice the Home Location Register is aware of this situation and further has the identifying information for the serving gateway. The home gateway is therefore able to identify 77 the serving gateway and to provide a 302 REDIRECT message 78 to the source to identify this serving gateway.

As described above, this 302 REDIRECT message 78 can additionally convey the information that the source (and hence the serving gateway) does not need to interrogate the serving gateway with respect to the location of the target, as the Home Location Register has already provided this information and effectively vouched for the present location information of the target. Pursuant to these teachings, then, the source is able to issue an INVITE message 79 to the serving gateway to not only identify the target but to also indicate that there is no need for the serving gateway to further interrogate the Home Location Register, nor its local cache memory, with respect to the present location of the target. Instead, the serving gateway can then simply effect its ordinary processes to complete establishing the desired communication link with the target as is registered in the service area of the serving gateway.

It will therefore be seen that, even under what essentially amounts to a worst case scenario, only two redirections are required to successfully connect an external source to a correct serving gateway when employing the above-described teachings. It will further be appreciated that, in the above illustrative example, neither the first gateway nor the home gateway had previously cached contact information that could have been employed to avoid at least one of these two redirection exercises. In many cases, these teachings will permit the collection and use of such cached information to effect such a reduction in redirection steps. Those skilled in the art will also further appreciate that, in the above illustrative example, only one interrogation of the Home Location Register was required to facilitate completion of the communication link notwithstanding that two redirections were employed to ultimately direct the source to the serving gateway.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept. For example, as described above, the gateway can optionally cache potentially useful information regarding a source from a communication system peer upon receiving a call routing message that identifies a target within the communication system served by the gateway. Similar caching behavior can also be applied when supporting interactions in a reverse direction, however. To illustrate, and referring now to FIG. 8, a gateway for a first communication network may be provided 81, which gateway again provides functionally partitioned interrogation and call signaling procedures for at least some, but not all, geographic service areas as comprise the first communication network. When this gateway transmits 82 a call routing message that identifies a target communication unit that is currently serviced by a second communication network (which second communication network again comprises a network that is a discrete and separate communication system peer relative to the first communication network), and upon receiving 83 a successful response (such as, for example, a Session Initiation Protocol-compatible 2000K message as is known in the art) to this call routing message (which successful response comprises, at least in part, an address that corresponds to the target communication unit), the gateway can automatically cache 84 that address. So configured and arranged, the gateway can then retrieve that cached address information for subsequent call routing activities, thereby likely reducing a need for future network and inter-network traffic when supporting subsequent calls to this particular target.

We claim:

1. A method to facilitate interaction between at least a first and second communication network, wherein the first and second communication networks comprise discrete and separate communication system peers, and wherein the first communication network is functionally partitioned at least with respect to interrogation and call signaling procedures over a plurality of geographic service areas, comprising:
providing a gateway for the first communication network that provides functionally partitioned interrogation and call signaling procedures for a first one of the plurality of geographic service areas, but not for at least one other of the plurality of geographic service areas:
receiving a call routing message from a source in the second communication network that identifies a target communication unit that is currently serviced by the first communication network;
processing the call routing message as a function, at least in part, of a home geographic service area and a serving geographic service area as corresponds to the target communication unit.

2. The method of claim 1 wherein receiving a call routing message further comprises receiving a Session Initiation Protocol INVITE message.

3. The method of claim 1 wherein processing the call routing message further comprises determining whether the call routing message identifies a specific call signaling server in the first communication network.

4. The method of claim 3 wherein determining whether the call routing message identifies a specific call signaling server in the first communication network further comprises an identification that specifies a particular status.

5. The method of claim 4 wherein processing the call routing message further comprises:
using the identification of the specific call signaling server when processing the call routing message when the particular status corresponds to a predetermined status;
not using the identification of the specific call signaling server when processing the call routing message when the particular status does not correspond to the predetermined status and cached information regarding identification of an appropriate call signaling server is available.

6. The method of claim 5 wherein processing the call routing message further comprises using the identification of the specific call signaling server when processing the call routing message even when the particular status does not correspond to the predetermined status when there is no cached information regarding identification of an appropriate call signaling server available.

7. The method of claim 3 wherein determining whether the call routing message identifies a specific call signaling server in the first communication network further comprises determining whether the call routing message identifies a location server for the target communication unit that is within a geographic service area as corresponds to interrogation facilitation services coverage of the gateway.

8. The method of claim 7 and further comprising, when the call routing message does not identify a location server for the target communication unit that is within a geographic service area as corresponds to interrogation facilitation services coverage of the gateway, redirecting the source to another gateway for the first communication network.

9. The method of claim 8 wherein redirecting the source further comprises indicating to the source that this redirection comprises at least a non-temporary redirection.

10. The method of claim 9 wherein the redirection comprises a Session Initiation Protocol-compatible 301 message.

11. The method of claim 1 wherein receiving a call routing message from a source in the second communication network that identifies a target communication unit that is currently serviced by the first communication network further comprises determining whether the target communication unit is within a geographic service area as corresponds to call signaling facilitation services of the gateway.

12. The method of claim 11 and further comprising, when the target communication unit is within a geographic service area as corresponds to call signaling facilitation services of the gateway, directing a call facilitation message to a call signaling server as corresponds to the target communication unit.

13. The method of claim 11 and further comprising, when the target communication unit is not within a geographic service area as corresponds to call signaling facilitation services of the gateway, redirecting the source to another gateway for the first communication network.

14. The method of claim 13 wherein redirecting the source further comprises indicating to the source that this redirection comprises a temporary redirection.

15. The method of claim 14 wherein the redirection comprises a Session Initiation Protocol-compatible 302 message.

16. The method of claim 1 wherein receiving a call routing message from a source in the second communication network that identifies a target communication unit that is currently serviced by the first communication network further comprising automatically caching information as corresponds to route information as corresponds to the source as is contained in the call routing message.

17. The method of claim 16 wherein automatically caching information as corresponds to route information further comprises automatically caching the information in response to detection of an explicit indication regarding such caching in the call routing message.

18. A method to facilitate interaction between at least a first and second communication network, wherein the first and second communication networks comprise discrete and separate communication system peers, and wherein the first communication network is functionally partitioned at least with respect to interrogation and call signaling procedures over a plurality of geographic service areas, comprising:
providing a gateway for the first communication network that provides functionally partitioned interrogation and call signaling procedures for a first one of the plurality of geographic service areas, but not for at least one other of the plurality of geographic service areas:
transmitting a call routing message from the gateway that identifies a target communication unit that is currently serviced by the second communication network;
receiving at the gateway a successful response to the call routing message, which successful response comprises, at least in part, an address as corresponds to the target communication unit;
caching, via the gateway, the address such that the address is available to the gateway to support subsequent call routing functionality.

19. The method of claim 18 wherein caching, via the gateway, the address further comprising automatically caching, via the gateway, the address.

20. The method of claim 19 wherein receiving at the gateway a successful response further comprises receiving a Session Initiation Protocol-compatible 2000K message.
